(19) United States
(12) Patent Application Publication
(10) Pub. No.: US 2006/0007845 A1
(43) Pub. Date: Jan. 12, 2006

(54) Information carrier and method and apparatus for manufacturing same

(76) Inventor: Hendricus Antonius Hoogland, Krommenie (NL)

Correspondence Address: Ronald J Baron;Hoffmann & Baron, 6900 Jericho Turnpike, Syosset, NY, 11791, US

(21) Appl. No.: 10/533,162

(22) PCT Filed: Nov. 3, 2003
(86) PCT No.: PCT/NL03/00769

§ 371 Date: Aug. 17, 2005

(30) Foreign Application Priority Data
Nov. 1, 2002 (NL) 1021814

(51) Int. Cl. G11B 3/70; B29D 17/00

(52) U.S. Cl. 369/273; 264/1.33; 425/542; 425/810

(57) ABSTRACT

The invention relates to a method for manufacturing plastic-shaped information carriers (1) such as CDs and DVDs and the like, wherein a disc (2) is injection molded and the disc (2) is provided with at least one label (3), while the label (3) contains at least one light reflective layer (4) visible at the side proximal to the disc (1), as well as to an information carrier such as a CD or a DVD, provided with a plastic disc (2) and a label (3), which label (3) comprises a light reflective layer (4) at the side proximal to the disc (1).

The invention relates to a method for manufacturing plate-shaped information carriers such as CDs, DVDs and the like.

As a rule, CDs, DVDs and such information carriers are manufactured through injection molding of a plastic disc, onto which disc, further, with the aid of a sputter technique, a reflective layer is applied. For pre-recorded CDs and DVDs it holds that then, the disc is formed in a so-called master mold, such that, due to a pattern of pits in a surface of the disc, electronic information is stored which is readable by light. The reflective layer then ensures that this information becomes readable with known players such as CD, CD-Rom, CD-I or DVD players. For recordable or rewriteable information carriers such as CDs, DVDs and CD-ROMs it holds that on the disc, a light sensitive layer is applied between the disc and the reflective layer.

Use of sputter techniques for applying a reflective layer onto the disc, optionally over a light sensitive layer, is complicated and relatively costly. After injection molding, the disc is to be taken out and to be transferred to a conditioned space where the reflecting metal layer is applied through sputtering. The reflective layer is to be applied particularly evenly without surface disturbances in order that the desired reflection of a laser beam in a player can be obtained. To that end, for instance, centrifugal means, vacuum chambers and the like are required, which makes the apparatuses required for the manufacture complicated and costly too.

The invention contemplates a method for the manufacture of information carriers such as CDs, DVDs CD-ROMs and such plate-shaped information carriers.

More in particular, the invention contemplates such a method with which at least a part of the above-mentioned drawbacks of the known method and apparatuses required therefor is obviated.

The invention further contemplates a method for manufacturing information carriers such as CDs, DVDs, CD-ROMs and such plate-shaped information carriers which can be used in a relatively simple injection molding apparatus, virtually without special, conditioned spaces being necessary.

The invention further relates to apparatuses suitable to and/or destined for the manufacture of information carriers such as CDs, DVDs, CD-ROMs and such plate-shaped information carriers, in particular for the use of methods according to the invention.

Furthermore, the invention relates to information carriers such as CDs, DVDs, CD-ROMs and such plate-shaped information carriers, manufactured in particular with an apparatus and/or method according to the invention.

The invention further relates to the use of labels, in particular in-mold labels for manufacturing information carriers such as CDs, DVDs, CD-ROMs and such plate-shaped information carriers.

These and other objects are achieved with a method, apparatus, information carrier and use according to the invention as will be elucidated hereinbelow.

Preferably, a method according to the invention is characterized in that a disc is injection molded and the disc is provided with at least one label, the label containing at least one light reflective layer, at the side proximal to the disc.

Such a method offers the advantage that a reflective layer can be applied onto the disc particularly rapidly and simply, without particularly complicated apparatuses and conditioned spaces being required to that end.

Preferably, in a method according to the invention, use is made of in-mold labeling techniques. With these, in an injection molding operation, an information carrier according to the invention can be manufactured in a mold. The disc does not need to be taken from the mold until after the reflective layer has been provided.

An information carrier according to the invention can be produced in a particularly advantageous and simple manner, while the apparatuses required to that end can be built up in an uncomplicated manner and from standard components, so that such apparatuses are relatively inexpensive in purchase and use, require little maintenance and can be of robust design.

With an information carrier according to the invention, a disc is or can be provided with readable information in a known manner, for instance in the form of surface deformations of the disc. Also, the label can be provided with a photo sensitive layer, which layer, at least in terms of functionality, is comparable to similar layers known from the state of the art and used in CD- or DVD-recordables and/or CD- and/or DVD rewriteables. Also, according to the invention, such a photo sensitive layer may have been or may be applied onto the disc, between the disc and the reflective layer of a label. Naturally, several information carrying or photosensitive layers can be provided, on which or from which information can be provided and/or can be read with the aid of, for instance, different types of light. To this end, for instance, a multi-layer film, at least multi-layer label can be used.

In a particularly advantageous embodiment, the label is included between two plastic layers, so that an even better protection and evenness can be obtained.

The invention further relates to a method for manufacturing plate-shaped, at least optically readable information carriers such as CDs and DVDs, being or not being at least partly recordable and/or rewriteable. Such information carriers are described hereinabove.

With pre-recorded information carriers, information is stored in the form of profiling in the surface, in particular a profile of pets. These are provided in the surface with the aid of a master mold. Manufacture of such a master mold is relatively costly and moreover, it is susceptible to damage, in particular when information density increases.

The invention contemplates providing an alternative method for manufacturing such information carriers, in particular information carriers as described hereinabove. To that end, with a method according to the invention, the information is provided on a disc, at least a carrier in the form of a pattern of “flats”. With the information carrier in front view, the appearance of the pattern of flats can correspond to the pattern of the earlier described pits. Therefore, when the information carrier is placed in a suitable playing device, the same information will be played as when a known information carrier with the respective pattern of pits is placed in the same playing device. Since, with a method according to the invention, the pattern of flats is not applied as a profile, it can be applied in a particularly simple manner, for instance through a printing technique, through printing on a plastic disc, at least carrier or, preferably, through an in-mold labeling technique. Then, in an advantageous embodiment, the pattern can be designed to be semi-transparent so that, under it, a second or further layer with information can be applied. Herein, semi-transparent is understood to mean a layer such that a portion of the incident light is reflected, at least scattered, and a portion of the incident light can pass. Such techniques for several layers of information are already known per se from DVDs, wherein, however, the information is recorded by deformations of the surface such as the already mentioned dents or pits.

In clarification of the invention, methods apparatus, information carriers and use according to the invention will be further elucidated with reference to the drawing. In the drawing:

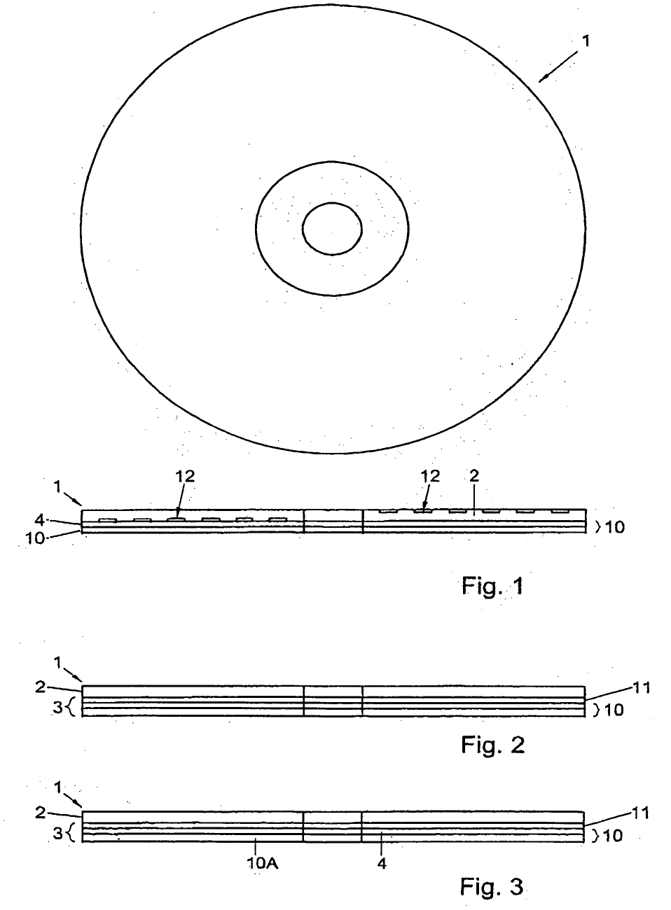

FIG. 1 schematically shows, in side and top plan view, an information carrier according to the invention, in a first embodiment; (refl.)

FIG. 2 schematically shows, in side view, an information carrier according to the invention, in a second embodiment; (refl.+pits)

FIG. 3 schematically shows, in side view, an information carrier according to the invention, in a third embodiment; (refl.+intermediate layer)

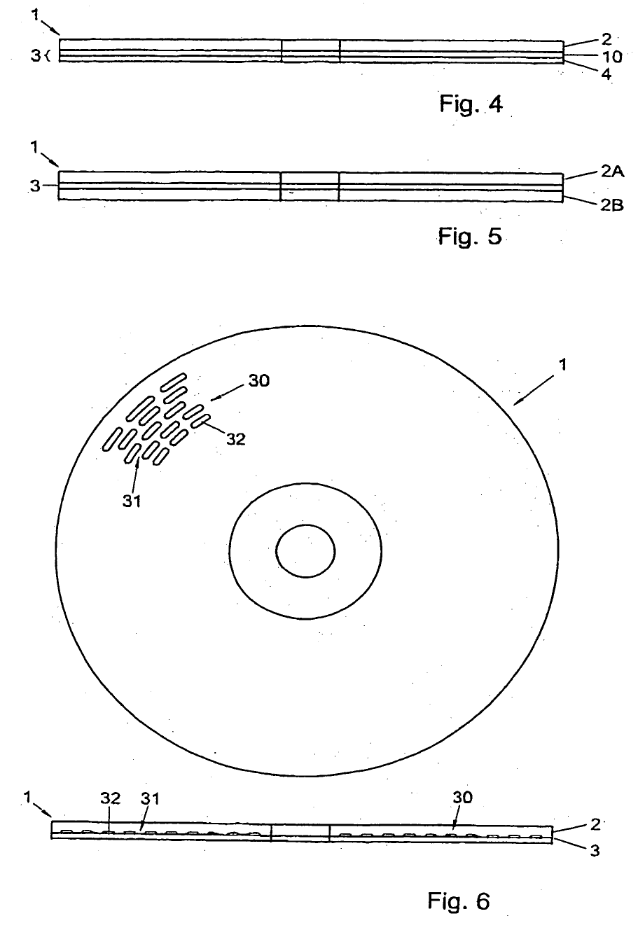

FIG. 4 schematically shows, in side view, an information carrier according to the invention, in a fourth embodiment; (refl. at rear side)

FIG. 5 schematically shows, in side view, an information carrier according to the invention, in a fifth embodiment; (intermediate layer)

FIG. 6 schematically shows, in front and side view, an information carrier according to the invention in a further advantageous embodiment;

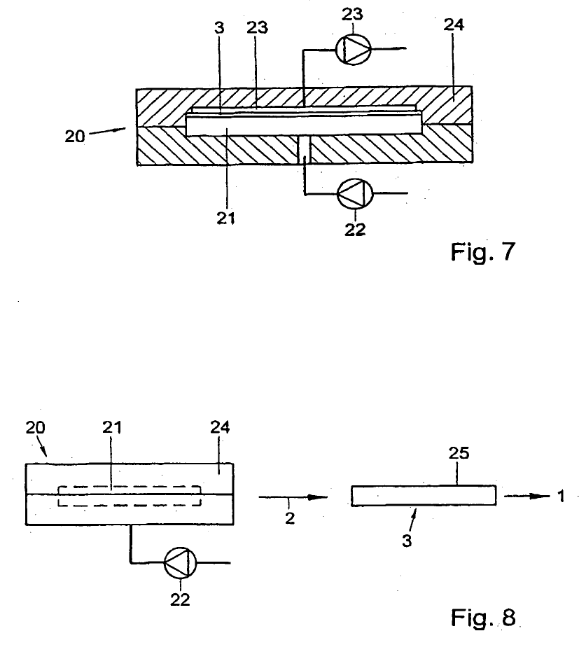

FIG. 7 schematically shows, in cross-sectional side view, an apparatus according to the invention, in a first embodiment;

FIG. 8 schematically shows, in cross-sectional side view, an apparatus according to the invention in a second embodiment;

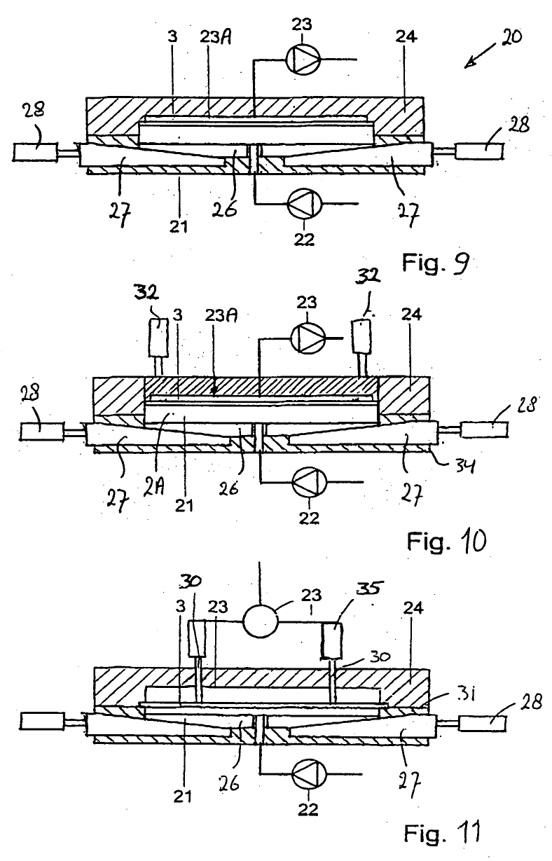

FIG. 9 schematically shows, in cross-sectional side view, a first alternative embodiment of a mold according to the invention;

FIG. 10 schematically shows, in cross-sectional side view, a second alternative embodiment of a mold according to the invention; and

FIG. 11 schematically shows, in cross-sectional side view, a third alternative embodiment of a mold according to the invention with a label 3 therein.

In this description, identical or corresponding parts have identical or corresponding reference numerals. All combinations of parts of the embodiments shown are to be understood as to have been explicitly described and shown.

In this description, information carrier is at least understood to mean any disc-shaped information carrier which, with the aid of light, in whatever color, frequency or intensity, can be read and/or can be provided with information, once or repeatedly. These are at least understood to include CDs in any form and sort, such as music and data CDs, CD-recordables, CD-rewriteables, CD-ROM, CD-I and the like, DVDs in any sort such as music and image DVDs, recordable and rewriteable DVDs, but the invention it not limited thereto. In this application, labels are understood to include at least but not exclusively, single-layer and multi-layer webs such as film, which can be printed on, be printed or otherwise be provided with prints, finishing layers and the like, in particular reflective, more in particular highly reflective layers and films, while the labels can be of the type usable for in-mold labeling as well as of the type which can be attached to a plastic surface, for instance by gluing or melting together. In this application, in-mold labeling is at least understood to include a method wherein, in a production mold, a label is fixedly connected to a plastic disc, in particular under the influence of temperature, more in particular by partial melting together of at least a part of the label with at least a part of the plastic.

In this application, a player is at least meant to include an apparatus for playing and/or applying information on an information carrier described hereinabove, in the broadest sense of the word. Where applicable in this application, light and light beams are understood to include light beams suitable for reading information from information carriers or, conversely, applying information thereon in these players, or in or with manufacturing devices for such information carriers. In particular, laser beams are meant to be included therein and light sources known per se of, substantially, monochrome light.

Materials for the manufacture of plastic discs for information carriers of the present type are sufficiently known and are understood to be incorporated herein. As an example, for instance, polycarbonate can be mentioned. However, this should not be taken as being limitative in any way. Further, also, photosensitive materials, and techniques for designing and processing these for use with such information carriers are sufficiently known, in particular of the recordable and/or rewriteable type. These materials and techniques too are understood to be incorporated herein.

FIG. 1 schematically shows, in top plan view and side view, an information carrier 1 according to the invention, for instance a CD or DVD. The information carrier 1 comprises a circular, plastic disc 2 with a label 3 thereon which is applied through in-mold labeling. The label 3 comprises a plastic carrier 10, for instance a film 10A with a reflective layer 4 thereon which is included between the film 10A and the disc 2. The reflective layer 4, which, preferably, is highly mirroring and reflects light, comprises, for instance, aluminum or a similar metal, provided on the film with the aid of printing or printer techniques, preferably on a film web from which, subsequently, the label 3 has been cut. However, other techniques too may have been used for applying the reflective layer 4, for instance known sputter techniques. Also, a film 3 can be used which is already reflective in itself, for instance a metal foil, optionally provided with a cover layer, such as a varnish layer or a plastic cover layer suitable for adhesion to the disc 2 upon in-mold labeling.

With the information carrier 1 according to the invention as shown in FIG. 1, in a customary manner through surface profiling, represented in FIG. 1 as dents 12, information has been stored in the plastic disc 2, readable with the aid of a light beam, in particular a laser light from a player suitable for the respective information carrier. The dents can be provided in the upper side (FIG. 1, right hand side) or in the underside (FIG. 1, left hand side). Such a disc can be manufactured in a master mold, which technique is known per se. However, according to the invention, in the embodiment shown in FIG. 1, a label is inserted into the mold, as schematically shown in FIG. 7, prior to injection of the plastic into the mold cavity 5 for forming the disc 2. This is an in-mold labeling technique known per se, as described, for instance, in patent applications NL 1012869 and WO 0117744, which applications are understood to be incorporated herein by reference.

In FIG. 2, schematically, in cross-sectional side view, a part of an information carrier according to the invention is shown, in a first alternative embodiment. In this embodiment, the label 3 comprises a carrier 10, for instance in the form of a film layer 10A, onto which a reflective layer 4 has been applied on the side proximal to the disc 2, on which reflective layer a light sensitive layer 11 has been applied, also called a photo-sensitive layer, as known for CD rewriteables and CD recordables, in which layer 11, during use, with the aid of suitable light information can be stored, or from which it can be read. Such layers are known from practice. According to the invention, preferably, with the aid of a printer technique, printing technique or the like, this layer 11 has been applied onto the film 10A before it is applied onto the disc 2. However, naturally, this layer 11 can also be applied in a different manner and it can also, first, be applied onto the disc 2 whereupon the label 3 is applied, for instance by gluing, melting together as known from sealing techniques, or similar attachment.

It will be clear that an information carrier 1 according to FIG. 2 is particularly suitable as a recordable or rewriteable information carrier, i.e. information carrier on which at least once and preferably repeatedly, information can be stored and from which it can be read by a user. Also, such an information carrier can, for instance, be used as CD-ROM However, in this manner, also different information carriers can be manufactured, for instance so-called “pre-recorded” CDs or DVDs.

In FIG. 3, in cross-sectional side view, an information carrier 1 according to the invention is shown, which, broadly speaking, can be seen as a combination of the embodiments of FIGS. 1 and 2. With this information carrier, information is stored in the plastic disc 2 in a customary manner, for instance through surface deformations 12, while the label 3, again, is provided with a reflective layer 4 and a light-sensitive or photo-sensitive layer 11. In the light-sensitive layer 11, a user can store additional information or read it therefrom, so that, for instance, an interactive information carrier can be obtained.

FIG. 4 shows a further alternative embodiment of an information carrier 1 according to the invention, wherein a label 3 is used comprising a substantially transparent, at least translucent carrier 10 while, on the side remote from the disc 2, a reflective layer 4 has been applied instead of on the side proximal to the disc 2. Such an embodiment can offer the advantage that the reflective layer 4 can be better protected during manufacture of the disc 2, in particular with in-mold labeling, while, furthermore, the carrier 10 can simply melt together, at least partially, with the plastic to be injected into the mold, so that a particularly good adhesion can be obtained without damaging or otherwise influencing the reflective layer 4. It will, for that matter, be clear that the reflective layer 4 on the side remote from the disc 2 can also be covered by, for instance, a protective layer such as film.

In FIG. 5, a further alternative embodiment is shown, particularly suitable for CD or DVD recordables or rewriteables, wherein the or each label 3 is included between a first disc 2A and a second disc 2B. Preferably, the two discs are manufactured from plastic as described earlier. Naturally, the or each label 3 can be attached to one of the discs 2A, 2B through gluing or be clamped between the discs, but it is preferred that the or each label 3 is applied through in-mold labeling. To that end, for instance the first disc 2A can be formed and be inserted into the mold as an insert, onto which the label 3 is placed. Then, the second disc 2B is injection molded against the side of the label 3 remote from the first disc 2A, so that the discs 2A, 2B and the interposed label 3 are fixedly interconnected. Alternatively, naturally, also the label can be applied against the first disc by in-mold labeling and, thereupon, the second disc 2B can be injection molded against it. An embodiment according to FIG. 5 offers the advantage that the film of the label 3 is well confined and protected by the two discs 2A, 2B while, moreover, the two discs 2A, 2B can contribute to the further evenness of the film. Naturally, all earlier described combinations of types of film and/or surface deformations can also be used in this variant.

Naturally, on the side remote from the disc, the labels of information carriers according to the invention can be provided with printing, for instance text, logos and the like, while, furthermore, writeable surfaces can be provided, so that information can be represented thereon by a user.

It will be clear that the labels of the exemplary embodiments shown in the different Figures can all be designed as shown in FIG. 4 too, and as labels described on the basis thereof.

In FIG. 6, schematically, in front and side view, an information carrier 1 according to the invention is shown, where a pattern 30 of flats 32 (of which only a part is represented) has been applied on a disc 2. The disc 2 can, for instance, be a plastic disc, while a reflective layer 4 is provided for reflecting incident light. Also, the disc can be a reflective disc, for instance a highly glossy aluminum disc. The pattern 30 of flats contains optically readable information, comparable to the earlier described pattern of pits known per se in the surface of a known CD or DVD or the like. In the embodiment shown, the surface of the disc is covered with a dark color or surface treatment or the like, at least absorbing and/or scattering the incident light. Openings 31 have been recessed therein forming the flats 32 which define the pattern. Light entering through these openings will be reflected by the reflective layer 4 or the disc 2, so that the information on the disc can be optically read by playing devices known per se for CDs or DVDs or the like. Alternatively, the flats 32 can be provided, in which case for instance a reflective surface treatment may be given. The further disc 2 can then, for instance, be designed to be transparent and/or absorbing and/or scattering. As a result, light only returns from the flats 32, not from the surroundings.

With an information carrier according to FIG. 6, the pattern 30, for instance, can be printed directly on the disc 2. Each flat 32, for instance, can then be applied in, for instance, light reflecting paint or ink. Also, the surroundings of the flats 32 can be printed in light absorbing or scattering ink or paint. In an alternative, advantageous embodiment, the pattern 30 is provided in a suitable manner on a label 3 which, thereupon, is processed in an information carrier in an earlier described manner. Additional information for controlling the readout means of the reading device for the information carrier, such as track information, can simply be printed along or be provided otherwise. Naturally, all earlier described elements can be combined with an information carrier 1 according to FIG. 6. Through the use of suitable materials for the pattern and as carriers 10 for the pattern, several optically readable layers can be provided on top of each other with the aid of a method according to the invention. Use can then be made, for instance, of partly reflective layers or contact surfaces, as known per se from DVDs.

In FIG. 7, schematically, in partly cross-sectioned side view, an apparatus 20 is shown for manufacturing an information carrier 1, in particular according to the invention. This apparatus comprises a mold cavity 21, in particular a master mold cavity and injection means 22 for injecting plastic into the mold cavity for forming a disc 2. Further, means 23 are provided for applying, with the mold 24 in opened condition, a label 3 in the mold cavity 21, at least against one of the wall parts such, that with the mold 24 closed, with the aid of the injection means 21, plastic can be injected against the label, so that the label 3 and the disc 2 start forming one entity, the information carrier 1.

In FIG. 8, schematically, an alternative embodiment of an apparatus 20 according to the invention is shown, wherein an injection mold 24 is provided with at least one mold cavity 21 in which plastic discs 2 can be manufactured, in a manner known per se, whereupon the discs 2 can be taken from the mold 24 and be transferred to a labeling station 25. In this labeling station 25, labels 3 are provided on one side of the disc 2, for instance by gluing or partial melting together, such as known heat seal techniques. Labels 3 can for instance be designed as stickers, i.e. provided with an adhesive layer. Such an adhesive layer should be selected such that light, entering through the disc, is not deflected thereby or otherwise influenced such that information provided on the information carrier is no longer readable or information can no longer be accurately provided thereon. Optionally, the adhesive layer can be designed as the reflective layer.

Naturally, for manufacturing an information carrier according to FIG. 5, an apparatus can be used comparable to that of FIGS. 7 and 8, wherein, however, means have been provided for inserting the first disc 2A as an insert or for enlarging the mold cavity after forming the first disc 2A, for forming the second disc 2B against the first disc 2A and a label 3 provided thereon. Labels can be punched or cut beforehand but can also be formed in the mold, in the manner known per se from the in-mold labeling technique. Also, labels can be cut or punched immediately prior to insertion into the mold cavity. These two latter techniques are indicated here as in place cutting. Here, labels can be supplied in a film web. Different films can be superposed for forming a multi-layer label, for instance a reflecting film and a light-sensitive few.

For manufacturing optically readable information carriers such as CDs and DVDs in the embodiments mentioned, it is of great importance that the labels be absolutely flat, at least be brought in a fixed position in or on the carrier such as a plastic disc. The fact is that the path to be traveled by the laser light for reading out and its refraction are very important in order for the information carrier to be accurately recorded on and/or read. That is why a manner of manufacture is preferred as described in, for instance, the non-prepublished Dutch patent application NL 1021421 of applicant, which is understood to be incorporated herein by reference. An embodiment of a mold 20 to be used therewith is schematically shown in cross-sectional side view in FIG. 9.

With such a method, the label is introduced into a mold cavity 21 for applying an in-mold labeling technique. The mold 20 then comprises at least one moveable wall part 26 with which, at least temporarily, the volume of the mold cavity can be enlarged. This wall part serves as a slide and is moveable, for instance with the aid of for instance hydraulic, pneumatic, mechanical or electrical means. In the embodiment shown, two wedges 27 are shown below the moveable wall part 26, drivable by hydraulic cylinders 28. The moveable wall part 26 can be moved relatively rapidly, for reasons to be described further.

During use, the mold 20 is opened and a label 3 is inserted into the mold in an earlier described manner, for instance against suction means 23A in a sidewall. Then, the mold is closed and, with the aid of the means 22, plastic is introduced into the mold cavity 21, while the moveable wall part 26 is in a retracted, first position. Therefore, the volume of the mold cavity is large with regard to the volume of the information carrier to be eventually formed. Then, during or, preferably, directly after the injection of the plastic into the mold cavity 21 against the label 3, the wall part 26 is moved forward in the direction of the label 3, with the aid of driving means 27, 28. This movement is carried out so rapidly that the moveable wall part causes adiabatic heat development in the plastic, as a result of compression and/or friction. Consequently, the plastic flows even better (the viscosity changes and the melt-flow-index improves for flowing) while the plastic is distributed at a very low pressure in the mold cavity 21, reducing, overall, in size. As a result of the relatively low pressures occurring with this method in the mold, the label is prevented from becoming deformed such as, stretched, displaced, wrinkled or otherwise deformed, or from becoming damaged. Consequently, the label 3 can be held in its place particularly accurately and an information carrier is obtained with a particularly high accuracy. As a result, the quality of the information storage is considerably improved and/or the storing capacity is considerably increased.

In FIG. 10 a mold is shown, comparable to that of FIG. 9, wherein however, a label 3 can be encapsulated between two layers of plastic, as shown, for instance, in FIG. 5 but which is not limited thereto. In this embodiment, the label 3 is brought against a first sidewall of a mold cavity. A moveable wall part placed at the opposite side is retracted and plastic is introduced against the label 3 in the above-described manner, while or whereupon the moveable wall part 26 is moved in the direction of the label 3. After the plastic has solidified somewhat, with the label adhering to the plastic, the part 2A of the information carrier formed, together with the label, is pulled back from the wall 23A against which the label 3 was placed, for instance by moving back the moveable wall part 26 or, as shown in the drawing, moving the wall part 23A with the aid of cylinders 32 in the direction away from the wall part 26. As a: result, on the respective side, space is formed adjacent the label 8. Then, in that space, a second quantity of plastic is introduced which is distributed in the mold cavity in a comparable manner, at least is spread in the space and is somewhat compressed by the wall part 23A moving back. As a result, on two opposite sides of a label 3, a plastic layer 2A, 2B is obtained and all at once, a ready-to-use information carrier is obtained.

With a method according to the invention as described with reference to FIGS. 9 and 10, use can be made of a master mold, at least a mold part with which the pits 12 can be provided in an information carrier. Since the pressures occurring in the plastic are relatively low, these parts forming the pits will remain undamaged relatively long, so that the quality of the information carrier is guaranteed longer without a new mold part needing to be inserted. The pit forming parts can, for instance, be provided on the moveable wall part 26 or on the opposite wall part In an alternative embodiment, one of the mold parts 24, 34 can be replaced by a different mold part, after a first side 2A of the plastic disc has been manufactured, provided or not provided with a label 3, so that, consequently, the desired space at the opposite side of the label is obtained. To that end, for instance, a carrousel-type mold can be used.

In a further alternative embodiment as shown in FIG. 11, the label 3 is supported in the mold cavity 21 on a series of legs 30—which can be extended with the aid of control means such as cylinders 35—or such supporting means and/or between the closing surfaces 31 of the mold 20, while at least one moveable wall part 26 is retracted. Then, the plastic is introduced into the mold such that the label 3 is entirely flowed around. As a result of the low pressure the label 3 can then be held flat in a simple manner. After and/or during filling of the mold cavity 21 and/or after and/or during movement of the or each moveable wall part 26 to a desired position moved forward, such that the desired eventual form of the mold cavity 21 is obtained, then, optionally, the legs 80 can be pulled back so that openings, having possibly formed as a result thereof, can be filled by the plastic. If the label 3 is retained between the closing surfaces 31 of the mold, during or after taking out of the mold, the edge of the information carrier can be cut or be machined otherwise for removing the projecting parts from the label 3.

Naturally, combinations can be formed of the different embodiments shown and described, for instance for obtaining a multi-layer information carrier, such as, for instance, a multi color DVD, while several labels can be inserted successively and be encapsulated with plastic.

It will be clear that discs for use with the invention are to be sufficiently transparent, at least translucent to light of the players suitable for the use thereof. In that respect, information carriers according to the invention need not deviate from known information carriers such as CDs and DVDs. Finishing means known per se can be used too, such as protective varnish layers and the like.

The invention is not limited in any way to the exemplary embodiments of information carriers, labels, manufacturing apparatuses or the use of labeling techniques represented in the description and the drawing. Many variations thereon are possible within the framework of the invention as outlined by the claims.

For instance, information carriers, in particular the discs for use therewith, can have any desired shape and size and can be provided or not be provided with a central opening. For the manufacture and placement of labels on the discs, at least in the mold cavities, all sorts of other known apparatuses and methods known from practice and literature, in particular patent literature, can be used, with which, for instance, labels can be manufactured in a mold, at least punched or cut, while all sorts of robots can be used. Also, in particular with an embodiment as shown in FIG. 4, through in-mold labeling, a disc can be provided with a label which, later, is provided with a finishing layer, for instance the reflective layer through printing or printer techniques. Such a method is particularly suitable when the plastic used for the disc is impossible or difficult to print on, since in that case suitable plastics for that purpose can be used for the label.

1. A method for manufacturing plate-shaped information carriers such as CDs, DVDs and the like, wherein a disc is injection molded and the disc is provided with at least one label, the label containing at least one light reflective layer which is visible at the side proximal to the disc.

2. A method according to claim 1, wherein the label is applied through in-mold labeling.

3. A method according to claim 1, wherein the disc is injection molded in a master mold such, that electronic information playable by a light beam, in particular a laser beam, is provided in the disc, while the disc is provided with the label for the purpose of, during use, reflecting light, at least for the greater part, entering through the disc.

4. A method according to claim 1, wherein the label comprises at least one light sensitive layer on which, with the aid of a light beam, in particular laser light, electronic information can be stored, thereby manufacturing a CD or DVD recordable or similar recordable information carrier.

5. A method according to claim 1, wherein the label comprises at least one light sensitive layer on which, with the aid of a light beam, in particular laser light, electronic information can be stored, thereby manufacturing a CD or DVD rewriteable or similar rewriteable information carrier.

6. A method according to claim 1, wherein the reflective layer is printed on the label or is applied with a printer.

7. A method according to claim 1, wherein the reflective layer is applied on the label by means of sputter technique.

8. A method according to claim 1, wherein the disc contains electronic information readable with a light beam or the like, and wherein the label is provided with at least one layer in which, with the aid of light, electronic information can be provided, which information is also readable with a light beam.

9. A method according to claim 1, wherein the labels are manufactured with the aid of in place cutting, directly prior to or during their insertion in a mold for in-mold labeling.

10. A method for manufacturing an optically readable information carrier, in particular according to claim 1, wherein through a suitable playing device such as a CD or DVD player, optically readable information is provided on the information carrier as a pattern of flats, which pattern has been provided in particular by printing or printer techniques.

11. A method according to claim 10, wherein the pattern has been provided on a label, which label is provided on a carrier during formation of the information carrier, in particular by in-mold labeling.

12. A method according to claim 1, wherein a mold is used with at least one mold cavity, wherein in the or each mold cavity at least one moveable wall part is provided which can be positioned into a first position where the respective mold cavity has a relatively large volume and, with the aid of driving means, can be moved to a second position, where said volume of the respective mold cavity is relatively small with regard to the volume when said wall part is in the first position, while, during movement of the respective wall part from the first to the second position, plastic is spread in the mold cavity.

13. A method according to claim 12, wherein said wall part is moved from the first to the second position so fast that in the plastic, adiabatic heat development occurs, so that the flow properties of the plastic are positively influenced.

14. A method according to claim 1, wherein a method according to NL 1021421 is used.

15. The use of in-mold labeling technique for the manufacture of plate-shaped information carriers such as CDs and DVDs.

16. An information carrier such as a CD or DVD, provided with a plastic disc and a label, which label contains a light reflective layer proximal to the disc.

17. An information carrier according to claim 16, wherein the information carrier is a recordable or rewriteable CD or DVD.

18. An information carrier, in particular according to claim 16, wherein optically readable information is provided in the form of a pattern of flats, which pattern, preferably, is provided through printing or printer techniques.

19. An information carrier according to claim 18, wherein said pattern is provided on a label applied through in-mold labeling.

20. An apparatus for manufacturing information carriers, comprising:
an injection mold with at least one cavity for forming a plastic disc; and
labeling means for applying on said disc a label provided with a light reflective layer.

21. An apparatus according to claim 20, wherein the labeling means are designed for providing the label on the disc in said at least one mold cavity.

22. An apparatus according to claim 20, wherein the labeling means are designed for providing the label on the disc outside said at least one mold cavity.

23. An apparatus according to claim 20, wherein further, means are provided for forming the labels from a film web, prior to or during placement of the labels.

24. An apparatus according to claim 20, wherein the apparatus is designed for in-mold labeling the disc.

25. An apparatus according to claim 20, wherein the apparatus is designed for providing on the disc at least two layers, while at least one layer is provided in the form of a label.

26. An apparatus according to claim 20, wherein at least one moveable wall part is provided with which the volume of the at least one cavity can be adjusted during an injection molding cycle.

27. An apparatus according to claim 26, wherein driving means are provided for said at least one moveable wall part with which this wall part can be moved so fast that in plastic in the respective cavity, adiabatic heat development occurs.
